(19) United States
(12) Patent Application Publication
(10) Pub. No.: US 2023/0295407 A1
(43) Pub. Date: Sep. 21, 2023

(54) Thermoplastic Vulcanizate Compositions Containing Metallocene Multimodal Copolymer Rubber and Processes for Making Same

(71) Applicant: EXXONMOBIL CHEMICAL PATENTS, Baytown, TX (US)

(72) Inventors: Prashant Arun Bhadane, Houston, TX (US); Wenfei Zhang, Shanghai (CN); Paul Douglas Zwick, Cypress, TX (US)

(21) Appl. No.: 18/010,903

(22) PCT Filed: May 17, 2021
(86) PCT No.: PCT/US2021/032738

§ 371 Date: Dec. 16, 2022

Related U.S. Application Data
(60) Provisional application No. 63/047,640, filed on Jul. 2, 2020.

(51) Int. Cl. C08L 23/16

(52) U.S. Cl. CPC C08L 23/16; C08L 2205/22; C08L 2205/035

(57) ABSTRACT

Thermoplastic vulcanizate (TPV) compositions containing metallocene-based multimodal copolymer rubber and processes for making same. A TPV composition can include: (a) a multimodal copolymer rubber containing ethylene derived units, greater than 50 wt % and less than 100 wt % of a major polymer fraction having a Mooney viscosity of about 15 ML(1+4@125° C. to about 120 ML(1+4@125° C.), greater than 0 wt % and less than 50 wt % of a minor polymer fraction having a Mooney viscosity of about 120 ML(1+4@125° C.) to about 1,500 ML(1+4@125° C.), an average molecular weight distribution (Mw/Mn) of about 2.0 to about 4.5, an average branching index of about 0.7 and to about 1.0, and less than 10 parts by weight oil per 100 parts by weight of the multimodal copolymer rubber; (b) at least one other oil; (c) at least one thermoplastic polymer; and (d) a curing system comprising at least one curative material and at least one curing agent.

### CROSS REFERENCE TO RELATED APPLICATIONS

This application claims the priority benefit of U.S. Ser. No. 63/047,640, filed Jul. 2, 2020, which is incorporated herein by reference.

### FIELD

Embodiments of the present invention generally relate to thermoplastic vulcanizate compositions. More particularly, such embodiments relate thermoplastic vulcanizate compositions containing metallocene-based multimodal copolymer rubber which is essentially free of extender oil and processes for making same.

### BACKGROUND

Thermoplastic vulcanizates (TPVs) include blends of dynamically cured rubber and thermoplastic polymer. The rubber can be dispersed within the thermoplastic polymer phase as finely-divided rubber particles. These compositions often advantageously demonstrate many of the properties of thermoset elastomers, yet they can be processed using common thermoplastic molding techniques such as injection molding, extrusion, and blow molding. Thermoplastic vulcanizates can be prepared by dynamically vulcanizing, i.e., curing, a rubber with a curative material while the rubber is being mixed with a thermoplastic polymer.

Ethylene-based elastomers or rubbers such as ethylene-propylene-diene (EPDM) elastomers are often suitable for use in TPV applications. However, such elastomers are typically polymers of very high molecular weight, which inherently possess very high viscosities, e.g., Mooney viscosities of greater than 200 ML(1+4@125° C.). This inherent characteristic of EPDM can result in difficulties related to the processability of such elastomers. For example, efficient blending of the EPDM elastomer during the TPV production process can be difficult to achieve. Extender oil is often added to the EPDM elastomer to “extend” the rubber phase and reduce the apparent viscosity of the TPV.

The required level of extender oil depends on the molecular weight of the EPDM elastomer but is usually sufficient to reduce the apparent viscosity of the oil extended EPDM to a Mooney viscosity of about 100 ML(1+4@125° C.) or below. Very high molecular weight EPDM elastomers that are suitable for use in the TPV production process typically contain about 50 to 125 phr of extender oil. Incorporating such large amounts of extender oil can be challenging because the oil often fails to dissolve completely in the EPDM elastomer, resulting in phase separation between the EPDM elastomer and the extender oil.

An exemplary EPDM elastomer that includes extender oil to improve its processability is Vistalon™ 3666 sold by ExxonMobil, which is a mono-modal, high molecular weight, amorphous elastomer prepared using a Ziegler-Natta catalyst. Amorphous elastomers often exhibit high creep flow and agglomeration and thus are available as large bales rather than as small particles.

Due to the problems associated with Ziegler-Natta based EPDM elastomers, metallocene-based EPDM elastomers have been developed that are suitable for use in the TPV production process. Such EPDM elastomers, which are prepared using a metallocene catalyst, usually have a relatively narrow molecular weight distribution, relatively linear molecules, and more crystallinity. As such, these metallocene-based EPDM elastomers can have an overall Mooney viscosity of less than about 90 ML(1+4@125° C.) and thus can exhibit good processability without the need for extender oil. Since these EPDM elastomers are more crystalline in nature, they advantageously exhibit less creep flow and agglomeration, and therefore can be sold as small particles. Unfortunately, current TPV products containing metallocene-based EPDM elastomers can have inferior physical properties compared to Ziegler-Natta based EPDM elastomers. Also, the physical properties of such TPV products are often trade-offs between extremes.

The TPV process typically involves adding the EPDM elastomer, a filler, a thermoplastic polymer, and a curing system to a reactor, followed by melt mixing these components and curing or dynamically vulcanizing the EPDM elastomer. The curing system can include a curative material and curing agents. Many of these materials do not melt and may adversely impact the physical properties if not added as a very fine powder or dust. The fine dust, however, tends to go airborne and can severely impact industrial hygiene. In addition, organic dust clouds can impose a dust explosion hazard.

A need therefore exists for TPV compositions that can be prepared economically on mass scale using metallocene-based EPDM elastomers that have a good balance of properties while maintaining industrial hygiene and safe operating conditions.

### SUMMARY

Thermoplastic vulcanizate compositions containing metallocene-based multimodal copolymer rubber which is essentially free of extender oil and processes for making same are provided. In one or more embodiments, a thermoplastic vulcanizate composition can include: (a) a multimodal copolymer rubber containing ethylene derived units, greater than 50 wt % and less than 100 wt % of a major polymer fraction having a Mooney viscosity of from about 15 ML(1+4@125° C.) to about 120 ML(1+4@125° C.), based on a total weight of the multimodal copolymer rubber, greater than 0 wt % and less than 50 wt % of a minor polymer fraction having a Mooney viscosity of from about 120 ML(1+4@125° C.) to about 1,500 ML(1+4@125° C.), based on the total weight of the multimodal copolymer rubber, an average molecular weight distribution (Mw/Mn) of from about 2.0 to about 4.5, an average branching index of from about 0.7 and to about 1.0, and less than 10 parts by weight oil per 100 parts by weight of the multimodal copolymer rubber; (b) at least one other oil; (c) at least one thermoplastic polymer; and (d) a curing system comprising at least one curative material and at least one curing agent.

In one or more embodiments, a process for making a thermoplastic vulcanizate composition can include: (a) introducing a multimodal copolymer rubber to a reactor, the multimodal copolymer rubber containing ethylene derived units, greater than 50 wt % and less than 100 wt % of a major polymer fraction having a Mooney viscosity of from about 15 ML(1+4@125° C.) to about 120 ML(1+4@125° C.), based on a total weight of the multimodal copolymer rubber; greater than 0 wt % and less than 50 wt % of a minor polymer fraction having a Mooney viscosity of from about 120 ML(1+4@125° C.) to about 1,500 ML(1+4@125° C.), based on the total weight of the multimodal copolymer rubber; an average molecular weight distribution (Mw/Mn) of from about 2.0 to about 4.5, an average branching index of from about 0.7 and to about 1.0, and less than 10 parts by weight oil per 100 parts by weight of the multimodal copolymer rubber; (b) concurrently or sequentially with respect to the multimodal copolymer rubber; introducing at least one thermoplastic polymer, at least one other oil, and a curing system to the reactor; (c) melt mixing the multimodal copolymer rubber, the at least one thermoplastic polymer, and the curing system; and (d) curing the multimodal copolymer rubber.

In one or more alternative embodiments, a process for making a thermoplastic vulcanizate can include: making a pre-vulcanization blend that includes (a) a multimodal copolymer rubber containing ethylene derived units, greater than 50 wt % and less than 100 wt % of a major polymer fraction having a first Mooney viscosity of from about 15 ML(1+4@125° C.) to about 120 ML(1+4@125° C.), based on a total weight of the multimodal copolymer rubber, greater than 0 wt % and less than 50 wt % of a minor polymer fraction having a second Mooney viscosity less than the first Mooney viscosity, and less than 10 parts by weight oil per 100 parts by weight the multimodal copolymer rubber and (b) at least one curing agent powder; introducing the pre-vulcanization blend to a reactor; concurrently or sequentially with respect to the pre-vulcanization blend, introducing at least one thermoplastic polymer, at least one other oil, and at least one curative material to the reactor; melt mixing the pre-vulcanization blend, the at least one thermoplastic polymer, and the at least one curative material; and curing the multimodal copolymer rubber. The pre-vulcanization blend can optionally include at least one filler powder, the at least one thermoplastic polymer, the at least one other oil, the at least one curative material, or combinations thereof.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “phr” means based on (per) hundred parts of rubber, “ppm” means parts per million, and “ppm wt” and “wppm” are used interchangeably and mean parts per million on a weight basis. All concentrations herein, unless otherwise stated, are expressed on the basis of the total amount of the composition in question.

The term “α-olefin” refers to any linear or branched compound of carbon and hydrogen having at least one double bond between the α and β carbon atoms. For purposes of this to specification and the claims appended thereto, when a polymer or copolymer is referred to as including an α-olefin, e.g., poly-α-olefin, the α-olefin present in such polymer or copolymer is the polymerized form of the α-olefin.

The term “polymer” refers to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The terms “rubber” and “elastomer” are used interchangeably and refer to an elastic polymeric substance made using polymerization techniques. The term “vulcanizate” refers to rubber that has been at least partially cured or hardened. The term “thermoplastic” refers to a polymeric material that becomes moldable at a certain elevated temperature and that solidifies upon cooling. The term “thermoplastic vulcanizate” refers to a material that includes at least partly vulcanized polymer dispersed in thermoplastic.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

A detailed description will now be provided. Each of the appended claims defines a separate invention, which for infringement purposes is recognized as including equivalents to the various elements or limitations specified in the claims. Depending on the context, all references to the “invention” can in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

### Thermoplastic Vulcanizate Composition

A thermoplastic vulcanizate (TPV) composition is disclosed that can include a multimodal copolymer rubber, which is essentially free of extender oil, at least one other oil, at least one thermoplastic polymer, and a curing system containing at least one curative material and at least one curing agent. The TPV composition can also contain a filler material, if desired. As used herein, the term “essentially free of extender oil” means that the multimodal copolymer rubber contains less than about 10 parts by weight oil per 100 parts by weight of rubber (also referred to as “parts per hundred rubber” or phr), preferably less than about 5 phr, more preferably less than about 1 phr. The TPV composition can contain particles of vulcanized, i.e., cured, rubber dispersed in a continuous phase or matrix of the thermoplastic polymer.

The multimodal copolymer rubber can include: ethylene derived units; greater than about 50 wt % and less than about 100 wt % of a major polymer fraction having a Mooney viscosity of from about 15 ML(1+4@125° C.) to about 120 ML(1+4@125° C.), based on a total weight of the multimodal copolymer rubber; greater than about 0 wt % and less than about 50 wt % of a minor polymer fraction having a Mooney viscosity of from about 120 ML(1+4@125° C.) to about 1,500 ML(1+4@125° C.), based on the total weight of the multimodal copolymer rubber; an average molecular weight distribution (M_{w}/Mₙ) of from about 1.5 to about 4.5; and an average branching index factor (BI) of from about 0.7 and to about 1.0. Accordingly, the multimodal copolymer rubber can have a relatively narrow molecular weight distribution and an overall Mooney viscosity of less than about 90 ML(1+4@125° C.), indicating that it can be easily processed and thus requires little or no extender oil. The multimodal copolymer rubber can almost be linear in structure, as indicated by its average branching index, and it can be completely amorphous or semi-crystalline in nature.

The multimodal copolymer rubber can be made by polymerization using a metallocene catalyst. The resulting rubber can be in the form of particles having a particle size of from about 0.5 mm and to about 15.0 mm, preferably from about 1.0 mm to about 10.0 mm, and more preferably from about 1.5 mm to about 8.0 mm. As used herein, “particle size” refers to the weight-average particle size. These particles can be dusted with, for example, more than about 0.1 phr to prevent the rubber particles from sticking together. Such particulates can include, for example polyethylene dust particulates, in-organic filler materials such as calcium carbonate, talc, clay etc.

Surprisingly, the TPV composition can have a good balance of properties that are better than those of conventional metallocene-based TPV compositions. Without intending to be limited by theory, it is believed that the above-mentioned attributes of the multimodal copolymer rubber can contribute to these improved properties. For example, the TPV composition can have a relatively uniform phase morphology, excellent surface aesthetics as indicated by a relatively low extrusion surface roughness (ESR), and a relatively high bond strength to other TPV materials. In particular, the TPV composition can have an ESR of from about 20 to about 200, preferably from about 25 to about 100, and most preferably from about 28 to about 80. The TPV composition also can have a bond strength of from about 1.0 MPa to about 5.0 MPa, more preferably from about 1.5 MPa to about 4.5 MPa, and most preferably from about 1.8 MPa to about 4.0 MPa. Due to having a relatively uniform phase morphology, the TPV composition can exhibit good molding performance and thus can be used in applications that require extrusion, injection molding, blow molding, and compression molding.

The TPV composition also unexpectedly exhibits excellent hardness, elongation at break, and tensile strength properties. In particular, the TPV composition can have a hardness of from about 30 ShoreA to about 55 ShoreD, preferably from about 35 ShoreA to about 50 ShoreD, and more preferably from about 40 Shore A to about 45 ShoreD. The TPV composition can have an elongation at break of from about 250% to about 900%, preferably from about 275% to about 800%, and more preferably from about 300% to about 750%. Also, the TPV composition can have an ultimate tensile strength of from about 2.0 MPa to about 15.0 MPa, preferably from about 2.5 MPa to about 14.0 MPa, and more preferably from about 3.0 MPa to about 13.0 MPa.

In addition, the TPV composition can have a relatively low relative density, i.e., specific gravity, and a relatively low apparent viscosity i.e., shear stress applied/shear rate. The specific gravity of the TPV composition can range from about 0.86 to about 1.40, preferably from about 0.87 to about 1.25, and more preferably from about 0.88 to about 1.2. The apparent viscosity of the TPV composition can range from about 30 Pa*s to about 150 Pa*s, preferably from about 40 Pa*s to about 140 Pa*s, and more preferably from about 50 Pa*s to about 130 Pa*s when measured at 1200 s⁻¹ shear rate.

The test methods used to determine the foregoing properties of the TPV composition are provided in the Examples below.

Since the TPV composition has a good balance of properties, the TPV composition can be employed for a wide variety of applications in, for example, the automotive, industrial, and consumer markets. For example, the TPV composition can be used to make hoses, sealants, gap fillers, floor mats, window seals, and weatherseals. The TPV composition also can be used in applications utilizing foam by subjecting the TPV composition to commonly known foaming techniques such as microcell, chemical, or water foaming.

In one or more embodiments, a process for making the TPV composition can include: introducing the multimodal copolymer rubber disclosed herein to a reactor such as a twin-screw extruder; concurrently or sequentially with respect to the multimodal copolymer rubber, introducing at least one thermoplastic polymer, at least one oil, and a curing system to the reactor; melt mixing the multimodal copolymer rubber, the at least one thermoplastic polymer, and the curing system; and curing the multimodal copolymer rubber. As used herein, “melt mixing” means placing in a molten state while mixing and “curing” means solidification of melt due to increase in molecular weight as a result of reaction. In some aspects, the at least one oil can be introduced before curing the multimodal copolymer rubber, and additional oil can be introduced to the reactor post the curative injection. In this case, a ratio of the oil introduced before curing to the additional oil introduced after can be less than about 1.00, less than about 0.85, or less than about 0.70.

In one or more additional embodiments, a pre-vulcanization blend of the multimodal copolymer rubber with one or more other ingredients, particularly ingredients in powder form such as the curing agent and the filler powder, can be prepared separately in a first step. A second-step can then include introducing the pre-vulcanization blend to a reactor and concurrently or sequentially introducing at least one thermoplastic polymer, at least one oil, and at least one curative material or curing agent to the reactor. The pre-vulcanization blend, the at least one thermoplastic polymer, and the at least one curative material or curing agent can then be melt mixed together, and the multimodal copolymer rubber can be cured. Alternatively, the at least one thermoplastic polymer, the at least one oil, and/or the at least one curative material or curing agent can be included in the pre-vulcanization blend rather than being added to the reactor separately from the blend.

Since the pre-vulcanization blend containing ingredients in powder form can be prepared in a separate step or even in a separate location from the TPV process, there is no need to be concerned with the risk of a dust explosion. Also, there is no need to be concerned that the use of fine powder during the vulcanization process could adversely affect industrial hygiene.

### Multimodal Copolymer Rubber

The multimodal copolymer rubber content in the TPV composition can range from about 10 wt % to about 60 wt %, preferably from about 15 wt % to about 50 wt %, and more preferably from about 20 wt % to about 40 wt %, based on a total weight of the TPV composition. The multimodal copolymer rubber can include ethylene derived units, α-olefin derived units, and diene derived units, preferably non-conjugated diene derived units.

The α-olefin derived units can be or can include C₃ to C₂₀ α-olefins such as 1-butene, 1-hexene, 4-methyl-1-pentene, 1-octene, 1-decene, or combinations thereof. The α-olefin derived units are preferably propylene, 1-butene, 1-hexene, 1-octene, or combinations thereof, more preferably propylene. The non-conjugated diene derived units can be or can include 5-ethylidene-2-norbornene (ENB), 1,4-hexadic, octadiene, 5-methyl-1,4-hexadiene, 3,7-dimethyl-1,6-octadiene, dicyclopentadiene (DCPD), norbornadiene, 5-vinyl-2-norbomene (VNB), or combinations thereof. Examples of suitable ethylene-propylene-diene (EPDM) rubbers include Vistalon™ 5601. Vistalon™ 5702, Vistalon™ 7001, Vistalon™ 9301, etc which are commercially available from ExxonMobil.

The amount of ethylene derived units present in the multimodal copolymer rubber can range from about 45 wt % to about 80 wt %, preferably from about 50 wt % to about 75 wt %, and more preferably from about 55 wt % to about 70 wt %, based on a total weight of the rubber. The amount of diene derived units present in the TPV multimodal copolymer rubber can range from about 1 wt % to about 10 wt %, preferably from about 2 wt % to about 8 wt %, and more preferably from about 3 wt % to about 6 wt %, based on a total weight of the rubber. The α-olefin derived units can make up the remainder of the polymer units.

Ethylene content can be determined by FTIR, ASTM D3900, and is not corrected for diene content. ENB diene content can be determined by FTIR, ASTM D6047. Other dienes can be measured via ¹H NMR.

The multimodal copolymer rubber can be characterized by a multimodal molecular weight distribution, which can be simply referred to as multimodal molecular weight. In one or more embodiments, the multimodal copolymer rubber can include at least two fractions. The multimodality can manifest itself as two distinct peaks or a main peak and a shoulder peak in the M_{w GPC LALLS} signal. This multimodality can be caused by the blending of a very high molecular weight component with a very low molecular weight component either as a result of sequential polymerization or by physical blending techniques.

The multimodal copolymer rubber can include greater than about 50 wt % and less than about 100 wt %, preferably greater than about 55 wt % and less than about 95 wt %, and more preferably greater than about 60 wt % and less than about 90 wt %, of a major polymer fraction. The major polymer fraction can have a Mooney viscosity of from about 15 ML(1+4@125° C.) to about 120 ML(1+4@125° C.), preferably from about 25 ML(1+4@125° C.) to about 90 ML(1+4@125° C.), and more preferably from about 30 ML(1+4@125° C.) to about 80 ML(1+4@125° C.), based on a total weight of the multimodal copolymer rubber.

The multimodal copolymer rubber can include greater than about 0 wt % and less than about 50 wt %, preferably greater than about 5 wt % and less than about 45 wt %, and more preferably greater than about 10 wt % and less than about 40 wt %, of a minor polymer fraction. The minor polymer fraction can have a Mooney viscosity of from about 120 ML(1+4@125° C.) to about 1,500 ML(1+4@125° C.), preferably from about 120 ML(1+4@125° C.) to about 1,100 ML(1+4@125° C.), and more preferably from about 120 ML(1+4@125° C.) to about 700 ML(1+4@125° C.), based on a total weight of the multimodal copolymer rubber.

The multimodal copolymer rubber can have an overall Mooney viscosity of from about 20 ML(1+4@125° C.) to about 90 ML(1+4@125° C.), preferably from about 25 ML(1+4@125° C.) to about 85 ML(1+4@125° C.), and more preferably from about 30 ML(1+4@125° C.) to about 80 ML(1+4@125° C.).

As used herein, Mooney viscosity is reported using the format: Rotor ([pre-heat time, min.]+[shearing time, min.]@measurement temperature, ° C.), such that ML (1+4@125° C.) indicates a Mooney viscosity determined using the ML or large rotor according to ASTM D1646-99, for a pre-heat time of 1 minute and a shear time of 4 minutes, at a temperature of 125° C.

Unless otherwise specified, Mooney viscosity is reported herein as ML(1+4@125.degree. C.) in Mooney units according to ASTM D-1646. However, Mooney viscosity values greater than about 100 cannot generally be measured under these conditions. In this event, a higher temperature can be used (i.e., 150° C.), with eventual longer shearing times (i.e., 1+8@125° C. or 150° C.). More preferably, the Mooney measurement for purposes herein is carried out using a non-standard small rotor. The non-standard rotor design is employed with a change in the Mooney scale that allows the same instrumentation on the Mooney instrument to be used with polymers having a Mooney viscosity over about 100 ML(1+4@125° C.). For purposes herein, this modified Mooney determination is referred to as Mooney Small Thin (MST). ASTM D1646-99 prescribes the dimensions of the rotor to be used within the cavity of the Mooney instrument. This method allows for both a large and a small rotor, differing only in diameter. These different rotors are referred to in ASTM D1646-99 as ML (Mooney Large) and MS (Mooney Small). However, EPDM rubbers can be produced at such high molecular weight that the torque limit of the Mooney instrument can be exceeded using these standard prescribed rotors. In these instances, the test is run using the MST rotor that is both smaller in diameter and thinner. Typically, when the MST rotor is employed, the test is also run at different time constants and temperatures. The pre-heat time is changed from the standard 1 minute to 5 minutes, and the test is run at 200° C. instead of the standard 125° C. The value obtained under these modified conditions is referred to herein as MST (5+4@200° C.). Note: the run time of 4 minutes at the end of which the Mooney reading is taken remains the same as the standard conditions. One MST point is approximately equivalent to 5 ML points when MST is measured at (5+4@200° C.) and ML is measured at (1+4@125° C.). Accordingly, for the purposes of an approximate conversion between the two scales of measurement, the MST (5+4@200° C.) Mooney value is multiplied by 5 to obtain an approximate ML(1+4@125° C.) value equivalent.

The MST rotor used herein has a diameter of 30.48+/−0.03 mm, a thickness of 2.8+/−0.03 mm (determined from the tops of serrations), and a shaft of 11 mm or less in diameter. The rotor has a serrated face and edge, with square grooves of about 0.8 mm width and depth of about 0.25-0.38 mm cut on 1.6 mm centers. The serrations will consist of two sets of grooves at right angles to each other thereby forming a square crosshatch.

The rotor is positioned in the center of the die cavity such that the centerline of the rotor disk coincides with the centerline of the die cavity to within a tolerance of +/−0.25 mm. A spacer or a shim can be used to raise the shaft to the midpoint, consistent with practices typical in the art for Mooney determination. The wear point (cone shaped protuberance located at the center of the top face of the rotor) is machined off flat with the face of the rotor.

Mooney viscosities of the multimodal copolymer rubber can be determined on blends of polymers herein. The Mooney viscosity of a particular component of the blend is obtained herein using the relationship shown in equation (1):

log ML=n_{A} log ML_{A}+n_{B} log ML_{B} (1)

wherein all logarithms are to the base 10; ML is the Mooney viscosity of a blend of two polymers A and B each having individual Mooney viscosities ML_{A} and ML_{B}, respectively; n_{A} represents the wt % fraction of polymer A in the blend; and n_{B} represents the wt % fraction of the polymer B in the blend.

Equation (1) can be used to determine the Mooney viscosity of blends comprising a high Mooney viscosity polymer (A) and a low Mooney viscosity polymer (B), which have measurable Mooney viscosities under (1+4@125° C.) conditions. Knowing ML, ML_{A} and n_{A}, the value of MLB can be calculated.

However, for high Mooney viscosity polymers (i.e., Mooney viscosity greater than 100 ML(1+4@125° C.), MLA can be measured using the MST rotor as described above. The Mooney viscosity of the low molecular weight polymer in the blend can then determined using Equation 1 above, wherein MLA is determined using the following correlation (2):

ML_{A} (1+4@125° C.)=5.13*MST_{A}(5+4@200° C.) (2)

In these or other embodiments, the Mooney viscosity of high molecular weight polymers can be determined by employing a Mooney viscometer model VR/1132 (Ueshima Seisakusho), which can measure Mooney viscosities up to 400 units.

The multimodal copolymer rubber disclosed herein can have a weight average molecular weight (M_{w}) of from about 100,000 g/mole to about 450,000 g/mole, preferably from about 125,000 g/mole to about 400,000 g/mole, and more preferably from about 150,000 g/mole to about 350,000 g/mole. The multimodal copolymer rubber also can have an average molecular weight distribution (MWD) of from about 2.0 and to about 4.5, preferably from about 2.0 to about 4.0, and more preferably from about 2.0 to about 3.5. As used herein, MWD, also referred to as polydispersity, represents the weight average molecular weight divided by the number average molecular weight (M_{w}/Mₙ) of the polymer. MWD can be determined using Gel Permeation Chromatography on a Waters 150 gel permeation chromatograph equipped with a differential refractive index (DRI) detector and a Chromatix KMX-6 using an on-line light scattering photometer. The determination can be made at 135° C. using 1,2,4-trichlorobenzene as the mobile phase and one of a Shodex (Showa Denko America, Inc) polystyrene gel column numbered 802, 803, 804 or 805. This technique is discussed in detail in LIQUID CHROMATOGRAPHY OF POLYMERS AND RELATED MATERIALS III, 207 (J. Cazes ed., Marcel Dekker, 1981), which is incorporated herein by reference. For more information, see U.S. Pat. No. 4,540,753 to Cozewith et al. and references cited therein, and Verstrate et al., 21 Macromolecules 3360 (1998). In the data disclosed herein, corrections for column spreading are not employed.

M_{w}/Mₙ is preferably calculated from elution times. These numerical analyses are performed using commercially available Beckman/CIS customized LALLS software in conjunction with the standard Gel Permeation package. Calculations involved in the characterization of polymers by ¹³C NMR follow the work of F. A. Bovey in “Polymer Conformation and Configuration,” Academic Press, New York, 1969. Reference to M_{w}/Mₙ implies that the M_{w} is the value reported using the LALLS detector and Mₙ is the value reported using the DRI detector.

The relative degree of branching of a polymer can be determined using an average branching index factor (BI), which is also referred to as an average branching index. The multimodal copolymer rubber disclosed herein can have a BI of from about 0.7 to about 1.0, preferably from about 0.8 to about 0.99, and more preferably from about 0.85 to about0.98, indicating that it is almost linear in structure.

The BI can be calculated using a series of four laboratory measurements of polymer properties in solution, as disclosed in VerStrate, Gary, “Ethylene-Propylene Elastomers,” Encyclopedia of Polymer Science and Engineering, 6, 2nd edition (1986), which is incorporated by reference herein. The four measurements are: (i) weight average molecular weight (M_{w}) measured using a low angle laser light scattering detector (LALLS) in combination with Gel Permeation Chromatography (GPC), abbreviated herein as “M_{w} GPC LALLS”; (ii) weight average molecular weight (M_{w}) determined using a differential refractive index (DRI) detector in combination with GPC, and abbreviated herein as “M_{w} GPC DR”; (iii) viscosity average molecular weight (Mᵥ) determined using a differential refractive index (DRI) detector in combination with GPC, and abbreviated herein as “Mᵥ GPC DRI”; and (iv) intrinsic viscosity (also referred to as inherent viscosity, and abbreviated IV) measured in decalin at 135° C. The first three measurements (i, ii, and iii) are obtained via GPC using a filtered dilute solution of the polymer in trichlorobenzene.

The BI can be determined using the following equation (3):

$$BI = \frac{{M}_{v , br} \times {M}_{w , GPC DRI}}{{M}_{w , GPS LALLS} \times {M}_{v , GPC DRI}} \qquad ( 3 )$$

where M_{v,br}=(IV/k)^{1/a}, “k” is a measured constant from a linear polymer as described by Paul J. Flory in PRINCIPLES OF POLYMER CHEMISTRY 310 (1953), the summation is over all the slices in the distribution, and wherein “a” is the Mark-Houwink constant (which equals 0.759 for ethylene-propylene-diene rubbers in decalin at 135° C.).

From equation (3), it follows that BI for a linear polymer is 1.0. For branched polymers, the extent of branching is defined relative to a linear polymer. At a constant number average molecular weight Mₙ, (M_{w})_{branch}>(M_{w})ₗᵢₙₑₐᵣ, BI for branched polymers is less than 1.0, and a smaller BI value denotes a higher level of branching. In instances where measuring IV in decalin is impossible, IV can be measured for comparison to the instant disclosure using a viscosity detector in tandem with DRI and LALLS detectors in a so-called GPC-3D instrument. In this case, “k” and “a” values are selected which are appropriate for the GPC solvent used in making the determination.

The multimodal copolymer rubber can be made using any suitable polymerization process known in the art. For example, the multimodal copolymer rubber can be made by forming the different fractions of the rubber using series reactors as described below, using parallel reactors, or via mechanical blending.

When the multimodal copolymer rubber is produced by direct polymerization, the catalyst used is preferably a single-site catalyst, generally with an activity and longevity sufficient to polymerize in a homogeneous environment at temperatures of at least 100° C. so that the different molecular weight fractions can be produced in successive reactors arranged in series by temperature and/or hydrogen control.

In one or more embodiments, the catalyst can be a bulky ligand transition metal catalyst, also known as a “metallocene” catalyst. The bulky ligand can contain a multiplicity of bonded atoms, preferably carbon atoms, that form a group, which can be cyclic with one or more optional hetero-atoms. The bulky ligand can be a cyclopentadienyl derivative, which can be mono- or poly-nuclear. One or more bulky ligands can be bonded to the transition metal atom. The bulky ligand is assumed, according to prevailing scientific theory, to remain in position in the course of polymerization to provide a homogenous polymerization effect. Other ligands can be bonded or coordinated to the transition metal, preferably detachable by a cocatalyst or activator, such as a hydrocarbyl or halogen-leaving group. It is assumed that detachment of any such ligand leads to the creation of a coordination site at which the olefin monomer can be inserted into the polymer chain. The transition metal atom can be a Group IV, V, or VI transition metal of the Periodic Table of Elements. The transition metal atom is preferably a Group IVB atom. While it is assumed that the transition metal in the active catalyst state is in the 4+ oxidation state and a positively charged cation, precursor transition metal complexes that are generally neutral can be in a lower oxidation state. Reference is made to U.S. Pat. No. 6,211,312 for a more detailed description of suitable metallocene complexes.

The catalyst can be derived from a compound represented by the formula (4) below:

[L]ₘM[X]ₙ (4)

wherein L is the bulky ligand, X is the leaving group, M is the transition metal, and m and n are such that the total ligand valency corresponds to the transition metal valency. Preferably, the catalyst is four coordinate such that the compound is ionizable to a 1+ valency state. The ligands L and X can be bridged to each other, and if two ligands L and/or X are present, they can be bridged. The metallocenes can be full-sandwich compounds having two ligands L, which are cyclopentadienyl groups, or half-sandwich compounds having one ligand L only, which is a cyclopentadienyl group.

Metallocenes can include those compounds that contain one or more cyclopentadienyl moieties in combination with a transition metal of the Periodic Table of Elements. The metallocene catalyst component can be represented by the general formula (Cp)mMRnR′p, wherein Cp is a substituted or unsubstituted cyclopentadienyl ring; M is a Group IV, V or VI transition metal; R and R′ are independently selected halogen, hydrocarbyl group, or hydrocarboxyl groups having 1-20 carbon atoms; m=I-3, n=0-3, p=O-3, and the sum of m+n+p equals the oxidation state of M.

In one or more embodiments, useful metallocenes can include biscyclopentadienyl derivatives of a Group IV transition metal, preferably zirconium or hafnium. See WO 1999/41294.

These derivatives can contain a fluorenyl ligand and a cyclopentadienyl ligand connected by a single carbon and silicon atom. (See WO 1999/45040 and WO 1999/45041). In certain embodiments, the Cp ring is unsubstituted and/or the bridge contains alkyl substituents such as alkylsilyl substituents to assist in the alkane solubility of the metallocene. See WO 2000/24792 and WO 2000/24793, which are fully incorporated herein by reference. Other metallocene catalyst systems can show a polymerization capability suitable for making the multimodal copolymer rubber disclosed herein. For example, EP 418044 uses a monocyclopentadienyl compound similar to that of EP 416815. Similar compounds are described in EP 420436. WO 1997/03992 shows a catalyst in which a single Cp species and a phenol are linked by a C or Si linkage, such as Me2C(Cp)(3-tBu-5-Me-2-phenoxy)TiCl.₂. WO 2001/05849 discloses Cp-phosphinimine catalysts, such as (Cp)((tBu)3P═N-)TiCl₂.

The catalyst can be used with a cocatalyst or activator which, it is assumed according to prevailing theory, helps form the metallocene cation. Aluminum alkyl derived activators can be used of which methyl alumoxane is a commonly known example. This material can also function as a scavenger and is commercially obtainable from Albemarle or Schering.

Non or weakly coordinating anion (NCA) generating activators of the type described in EP 277004 are preferred. These activators are often used and described in conjunction with the metallocene in the above metallocene patent references. NCA's can be generated from precursors which can be a neutral salt containing the stabilizing anion or a nonionic Lewis Base capable of abstracting a group from the transition metal complex to form a stabilizing anion. The NCA can, depending on mode of generation, have three or four ligands substituted on a metal atom such as boron or aluminum. The ligands are preferably fluorinated, more preferably perfluorinated, aromatic moieties such as phenyl bisphenyl or naphthyl. Reference is also made to WO 2001/42249, which describes another suitable NCA structure and is fully incorporated herein by reference.

The high catalyst activity and low catalyst concentration typically employed on a commercial scale can lead to increased sensitivity to poisons. Poisons can enter into the polymerization reactor as impurities in the solvent or monomer feed or be generated by secondary processes such as a catalyst killing operation, which is generally performed with water after polymerization proper is completed. These poisons can be deactivated by using an alkyl aluminum scavenger such as triethylaluminum, (TEAL), titanium boron aluminum (TIBAL) or n-octyl aluminum. The presence of poison can also be countered by providing a molecular sieve or other purifying installation as part of the recycle in the continuous reactor lay out.

Conditions between the first and the second reactor can be differentiated as described in WO 1999/45047. Generally, a terpolymer (containing a suitable diene) can be made using ethylene, a higher α-olefin (e.g. propylene, 1-butene, 1-hexene, and 1-octene), and non-conjugated diene in a process which comprises: a) feeding a first set of monomers containing a diene to a first reactor; b) adding a single site catalyst to the first reactor; c) operating the first reactor to polymerize the first set of monomers to produce an effluent containing a first polymer component and optionally unreacted monomers; d) feeding the effluent of c) to a second reactor; e) feeding a second set of monomers to the second reactor; and f) operating the second reactor to polymerize the second set of monomers and any unreacted monomers to produce a second polymer component. Optionally, additional catalyst can also be fed to the second reactor. The final polymer product can contain a mixture of the first and second polymer components.

After polymerization and any catalyst deactivation or killing, the solvent can be removed by one or more flashing steps or a liquid phase separation as described in EP 552945 so that the solvent content is lowered to 0.1 wt % or less. The solvent can be recycled, and the polymer can be baled or pelletized.

### Thermoplastic Polymer

The thermoplastic polymer content in the TPV composition can range from about 20 phr to about 600 phr, preferably from about 25 to about 500 phr, and more preferably from about 30 phr to about 400 phr. The thermoplastic polymer can include those thermoplastic polymers that are commonly used in the manufacture of thermoplastic vulcanizates. For example, these thermoplastic polymers, which can be referred to as thermoplastic resins or unfunctionalized thermoplastics, can include solid, generally high molecular weight polymer resins. Examples of suitable thermoplastic polymers can be or can include crystalline, semi-crystalline, and crystallizable polyolefins, olefin copolymers, and non-olefin polymers.

The thermoplastic polymer can be or can include a polyolefin homopolymer, a polyolefin copolymer, or combinations thereof having a melt flow rate (MFR) of from about 0.10 to about 100.00, preferably from about 0.25 to about 50.00, and more preferably from about 0.50 to about 30.00. In one or more embodiments, the thermoplastic polymer can be formed by polymerizing ethylene or α-olefins such as propylene, 1-butene, 1-hexene, 1-octene, 2-methyl-1-propene, 3-methyl-1-pentene, 4-methyl-1-pentene, 5-methyl-1-hexene, or mixtures thereof. Copolymers of ethylene and propylene and ethylene and/or propylene with another α-olefin such as 1-butene, 1-hexene, 1-octene, 2-methyl-1-propene, 3-methyl-1-pentene, 4-methyl-1-pentene, 5-methyl-1-hexene, or mixtures thereof are also contemplated. Specifically included are the reactor, impact, and random copolymers of propylene with ethylene or the higher α-olefins disclosed above, or with C₁₀-C₂₀ diolefins. Comonomer contents for these propylene copolymers can be from 1 wt % to about 30 wt % by weight of the polymer, for example, see U.S. Pat. No. 6,867,260 B2. Examples of suitable copolymers are commercially available from ExxonMobil under the tradename VISTAMAXX™. Other polyolefin copolymers can include copolymers of olefins with styrene such as styrene-ethylene copolymer or polymers of olefins with α, β-unsaturated acids or α, β-unsaturated esters such as polyethylene-acrylate copolymers. Non-olefin thermoplastic polymers can include polymers and copolymers of styrene, α,β-unsaturated acids, α, β-unsaturated esters, and mixtures thereof. For example, polystyrene, polyacrylate, and polymethacrylate can be used. Blends or mixtures of two or more polyolefin thermoplastics such as described herein, or with other polymeric modifiers, are also suitable. Useful thermoplastic polymers can also include impact and reactor copolymers.

In one or more embodiments, the thermoplastic resins can include propylene-based polymers, including those solid, generally high-molecular weight polymer resins that primarily comprise units derived from the polymerization of propylene. In certain embodiments, at least 75%, in other embodiments at least 90%, in other embodiments at least 95%, and in other embodiments at least 97%, of the units of the propylene-based polymer derive from the polymerization of propylene. In particular embodiments, these polymers include homopolymers of propylene.

In certain embodiments, the propylene-based polymers can also include units deriving from the polymerization of ethylene and/or .alpha.-olefins such as 1-butene, 1-hexene, 1-octene, 2-methyl-1-propene, 3-methyl-l-pentene, 4-methyl-1-pentene, 5-methyl-1-hexene, and mixtures thereof.

In one or more embodiments, propylene-based polymers can include semi-crystalline polymers. In one or more embodiments, these polymers can be characterized by a crystallinity of at least 25% by weight, in other embodiments at least 55% by weight, in other embodiments at least 65%, and in other embodiments at least 70% by weight. Crystallinity can be determined by dividing the heat of fusion of a sample by the heat of fusion of a 100% crystalline polymer, which is assumed to be 209 J/g for polypropylene. In one or more embodiments, these polymers can be characterized by a Hf of at least 52.3 J/g, in other embodiments in excess of 100 J/g, in other embodiments in excess of 125 J/g, and in other embodiments in excess of 140 J/g.

In one or more embodiments, useful propylene-based polymers can be characterized by a M_{w} of from about 50 to about 2,000 kg/mole, and in other embodiments from about 100 to about 600 kg/mole. They can also be characterized by a Mₙ of about 25 to about 1,000 kg/mole, and in other embodiments about 50 to about 300 kg/mole, as measured by GPC with polystyrene standards.

In one or more embodiments, useful propylene-based polymers can have a melt flow rate (MFR) (ASTM D-1238, 2.16 kg@230° C.) of less than 100 dg/min, in other embodiments less than 50 dg/min, in other embodiments less than 10 dg/min, and in other embodiments less than 5 dg/min. In these or other embodiments, the propylene-based polymers can have an MFR of at least 0.1 dg/min, in other embodiments 0.2 dg/min, and in other embodiments at least 0.5 dg/min.

In one or more embodiments, useful propylene-based polymers can have a melt temperature (Tm) that is from about 110° C. to about 170° C., in other embodiments from about 140° C. to about 168° C., and in other embodiments from about 150° C. to about 165° C. The propylene-based polymers can have a glass transition temperature (Tg) of from about −10° C. to about 10° C., in other embodiments from about −3° C. to about 5° C., and in other embodiments from about 0° C. to about 2° C. In one or more embodiments, the propylene-based polymers can have a crystallization temperature (Tc) of at least about 75° C., in other embodiments at least about 95° C., in other embodiments at least about 100° C., and in other embodiments at least 105° C., with one embodiment ranging from 105° C. to 130° C.

The propylene-based polymers can be synthesized by using an appropriate polymerization technique known in the art. For example, the propylene-based polymers can be polymerized using Ziegler-Natta catalysts or single-site organometallic catalysts such as metallocene catalysts.

In particular embodiments, the propylene-based polymers include a homopolymer of a high-crystallinity isotactic or syndiotactic polypropylene. This polypropylene can have a density of from about 0.89 to about 0.91 g/cc, with the largely isotactic polypropylene having a density of from about 0.90 to about 0.91 g/cc. Also, high and ultrahigh molecular weight polypropylene that has a fractional melt flow rate can be employed. In one or more embodiments, polypropylene resins can be characterized by a MFR (ASTM D-1238; 2.16 kg@230° C.) that is less than or equal to 10 dg/min, in other embodiments less than or equal to 1.0 dg/min, and in other embodiments less than or equal to 0.5 dg/min.

Examples of suitable polypropylene polymers include PP5341 (0.8 MFR), PP1074NKE1 (20 MFR), and PP3854E1 (24 MFR), which are commercially available from ExxonMobil, and PP F180A (17 MFR), which is commercially available from Braskem America, Inc. Examples of suitable polyethylene polymers include LD051.LQ (0.25 MI), LL3001.32 (1 MFR), LL6407.67 (6.8 MI), and HD7845.30 (0.45 MI), which are commercially available from ExxonMobil. Post-consumer recycled polyolefins can also be used. Examples of suitable post-consumer recycled polypropylene and polyethylene include KW308A (8 MFR), KW622 (10 MFR and 20 MFR), KWR621FDA (10 MFR and 20MFR), KWR102 (0.5 MI), KWR105 (4 MI), which are commercially available from KW Plastics.

### Oil

The oil content in the TPV composition can range from about 10 phr to about 250 phr, preferably from about 50 phr to about 200 phr, and most preferably from about 75 phr to about 150 phr. The oil can be or can include mineral oil, synthetic oil, or combinations thereof

Suitable mineral oils for use in the TPV composition include aromatic, naphthenic, paraffinic, isoparaffinic oils, and combinations thereof The mineral oils can be treated or untreated. Useful mineral oils can be obtained under the tradename SUNPAR™ 150, which is commercially available from HollyFrontier, Paramount™ 6001, which is commercially available from Chevron Corporation, and PLASTOL™ 517, which is commercially available from ExxonMobil.

In one or more embodiments, suitable synthetic oils can include polymers and oligomers of butenes such as isobutene, 1-butene, 2-butene, butadiene, and mixtures thereof. In one or more embodiments, these oligomers can be characterized by a Mₙ of from about 300 g/mole to about 9,000 g/mole, and in other embodiments from about 700 g/mole to about 1,300 g/mole. In one or more embodiments, these oligomers can include isobutenyl mer units. Exemplary synthetic oils can include polyisobutylene, poly(isobutylene-co-butene), and mixtures thereof. In one or more embodiments, suitable synthetic oils also can include polylinear α-olefins, poly-branched α-olefins, hydrogenated poly-α-olefins, and mixtures thereof.

In one or more embodiments, suitable synthetic oils can include synthetic polymers or copolymers having a viscosity in excess of about 20 cp, in other embodiments in excess of about 100 cp, and in other embodiments in excess of about 190 cp, where the viscosity is measured by a Brookfield viscometer according to ASTM D-4402 at 38° C. In these or other embodiments, the viscosity of these oils can be less than 4,000 cp and in other embodiments less than 1,000 cp.

Useful synthetic oils can be obtained under the tradenames Polybutene™, which is commercially available from Soltex, and Indopol™, which is commercially available from Innouvene. White synthetic oil, which is commercially available from ExxonMobil under the tradename SPECTRASYN™ (ExxonMobil), can also be used. Oils described in U.S. Pat. No. 5,936,028 can also be employed. It is believed that synthetic oils can provide enhanced low temperature performance. Also, high temperature performance can be enhanced based upon molecular structure.

### Curing System

The TPV composition can contain a curing system that includes a curative material and a curing agent. The curative material can serve to cure or harden the multimodal copolymer rubber during the thermoplastic vulcanization process. The curing agent can be used in conjunction with the curative material to accelerate the curing process. The amount of the curative material present in the TPV composition can range from about 0.1 phr to about 20.0 phr, preferably from about 0.5 phr to about 10.0 phr, and more preferably from about 1.0 phr to about 5.0 phr. The amount of the curing agents present in the TPV composition can range from about 0.10 phr to about 10.00 phr, preferably from about 0.25 phr to about 6.00 phr, and more preferably from about 0.50 phr to about 3.00 phr.

Examples of suitable curative materials include phenolic-based polymers, silicon-containing materials, and peroxides (i.e., free-radical curative materials).

Useful phenolic-based polymer curative materials are disclosed in U.S. Pat. Nos. 2,972,600, 3,287,440, 5,952,425 and 6,437,030. In one or more embodiments, the phenolic-based polymer can include resole polymers, which can be made by the condensation of alkyl substituted phenols or unsubstituted phenols with aldehydes, preferably formaldehydes, in an alkaline medium or by condensation of bi-functional phenoldialcohols. The alkyl substituents of the alkyl substituted phenols can contain 1 to about 10 carbon atoms. Dimethylolphenols or phenolic polymers, substituted in para-positions with alkyl groups containing 1 to about 10 carbon atoms can be employed.

An exemplary phenolic-based polymer used as a curative material is a blend of octylphenol-formaldehyde and nonylphenol-formaldehyde polymers. In one or more embodiments, the blend can include from about 25 to about 40 wt % octylphenol-formaldehyde and from about 75 to about 60 wt % nonylphenol-formaldehyde, and in other embodiments, from about 30 to about 35 wt % octylphenol-formaldehyde and from about 70 to about 65 wt % nonylphenol-formaldehyde. In one embodiment, the blend can include about 33 wt % octylphenol-formaldehyde and about 67wt % nonylphenol-formaldehyde, wherein each of the octylphenol-formaldehyde and nonylphenol-formaldehyde include methylol groups. This blend can be solubilized in paraffinic oil at about 30% solids without phase separation.

Useful phenolic-based polymers can be obtained under the tradenames SP-1044 and SP-1045, which are commercially available from Schenectady International and may be referred to as alkylphenol-formaldehyde polymers. SP-1045 is believed to be a blend of octylphenol and nonylphenol formaldehyde polymers that contains methylol groups. The SP-1044 and SP-1045 polymers are believed to be essentially free of halogen substituents or residual halogen compounds. By essentially free of halogen substituents, it is meant that the synthesis of the polymer provides for a non-halogenated polymer that may only contain trace amounts of halogen-containing compounds.

An example of a suitable phenolic-based polymer can be defined according to the following general formula (5):

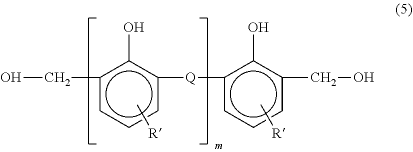

where Q is a divalent radical selected from the group consisting of —CH₂—, —CH₂—O—CH₂—; m is zero or a positive integer from 1 to 20 and R′ is an organic group. In one embodiment, Q is the divalent radical —CH₂—O—CH₂-, m is zero or a positive integer from 1 to 10, and R′ is an organic group having less than 20 carbon atoms. In other embodiments, m is zero or a positive integer from 1 to 10 and R′ is an organic radical having between 4 and 12 carbon atoms.

In one or more embodiments, the phenolic-based polymer is used in conjunction with a curing agent such as stannous chloride and metal oxide such as zinc oxide, which is believed to function as a scorch retarder and acid scavenger and/or polymer stabilizer. A suitable type of zinc oxide is commercially available from Horsehead, Corp. under the tradename Kadox™ 911. The zinc oxide can have a mean particle diameter of about 0.05 to about 0.15 μm. In other embodiments, a curing agent that serves as an acid scavenger, e.g., a hydrotalcite, can be added downstream of cure.

Free-radical curative materials can include peroxides such as organic peroxides. Examples of organic peroxides include di-tert-butyl peroxide, dicumyl peroxide, t-butylcumyl peroxide, α, α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy)valerate, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals, and mixtures thereof can be used. Other suitable peroxide include azo initiators such as LuazoTM AP, which is commercially available from Archema. Useful peroxides and their methods of use in dynamic vulcanization of thermoplastic vulcanizates are disclosed in U.S. Pat. No. 5,656,693, which is incorporated herein by reference. In certain embodiments, curing systems such as those described in U.S. Pat. No. 6,747,099, U.S. Patent Application Publication No. 2004/0195550, and International Patent Application Publication Nos. 2002/28946, 2002/077089, and 2005/092966, can also be employed.

In one or more embodiments, the free-radical curative material can be employed in conjunction with one or more curing agents. Suitable curing agents include high-vinyl polydiene or polydiene copolymer, triallylcyanurate, triallyl isocyanurate, triallyl phosphate, sulfur, N,N′-m-phenylenedimaleimide, N,N′-p-phenylenedimaleimide, divinyl benzene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, multi-functional acrylates, multi-functional methacrylates, oximers such as quinone dioxime, or mixtures thereof. Combinations of high-vinyl polydienes and α-β-ethylenically unsaturated metal carboxylates are useful, as disclosed in U.S. patent application Ser. No. 11/180,235. Curing agents also can be employed as neat liquids or together with a carrier. For example, suitable multi-functional acrylates or multi-functional methacrylates that are used with a carrier are disclosed in U.S. patent Publication Ser. No. 11/246,773. Also, the curative material and/or curing agent can be pre-mixed with the plastic prior to formulation of the thermoplastic vulcanizate, as described in U.S. Pat. No. 4,087,485.

Silicon-containing curative materials can include silicon hydride compounds having at least two SiH groups. Examples of silicon hydrides include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and mixtures thereof. Such hydrosilylation curative materials are particularly useful with monomodal copolymer rubber that includes diene units derived from 5-vinyl-2-norbornene.

Examples of curing agents that serve as catalysts for hydrosilylation include transition metals of Group VIII and complexes of these metals. For example, palladium, rhodium, and platinum can be used as curing agents. Useful silicon-containing curative materials and curing agents are disclosed in U.S. Pat. No. 5,936,028.

Those skilled in the art can appreciate that the amount of curative material used to make the TPV composition can vary based upon the chemical nature of the curative material and/or curing agent used in conjunction therewith. In these or other embodiments, the amount of curative material employed can vary based upon the type of monomodal copolymer rubber that is used as well as the cross-linkable units present within the rubber.

### Filler Material

Filler material can be included in the TPV composition in an amount of from about 0 phr to about 300 phr, preferably from about 0 phr to about 200 phr, and more preferably from about 0 phr to about 100 phr. Examples of suitable fillers include carbon black, clay, talc, silica, titanium dioxide, calcium carbonate, and combinations thereof

Such filler material, which has a relatively high specific gravity, is often used in conventional TPV compositions containing rubber available in bales as a cheap way to partition the bales being fed to the TPV reactor. In one or more embodiments, the filler material can be significantly reduced or even eliminated to obtain lower density TPV compositions. This reduction in the filler material is possible because the multimodal copolymer rubber disclosed herein can be fed in the form of smaller particles rather than bales, thus eliminating the need for a partitioning agent.

### Other Additives

In one or more embodiments, the TPV composition can include a polymeric processing additive that has a very high melt flow index. Suitable polymeric processing additives include both linear and branched polymers that have an MFR that is greater than about 500 dg/min, greater than about 750 dg/min, greater than about 1,000 dg/min, greater than about 1,200 dg/min, or greater than about 1,500 dg/min. Mixtures of various branched or various linear polymeric processing additives, as well as mixtures of both linear and branched polymeric processing additives, can be employed. Useful linear polymeric processing additives include polypropylene homopolymers. Useful branched polymeric processing additives include diene-modified polypropylene polymers. Suitable processing additives are also disclosed in U.S. Pat. No. 6,451,915.

The TPV composition can optionally include other additives such as compatibilizers, pigments, colorants, dyes, dispersants, flame retardants, antioxidants, conductive particles, UV-inhibitors, UV-stabilizers, adhesion promoters, fatty acids, esters, paraffin waxes, neutralizers, metal deactivators, tackifiers, calcium stearate, dessicants, stabilizers, light stabilizers, light absorbers, coupling agents, e.g., silanes and titanates, plasticizers, lubricants, blocking agents, anti-blocking agents, antistatic agents, waxes, foaming agents, nucleating agents, slip agents, acid scavengers, lubricants, adjuvants, surfactants, crystallization aids, polymeric additives, defoamers, preservatives, thickeners, rheology modifiers, humectants, curing retarders, reinforcing and non-reinforcing fillers, and combinations thereof as well as other processing aids commonly known in the rubber compounding art. These additives can be present in an amount up to about 50 wt % of the total TPV composition.

### Vulcanization Process

The TPV composition can be prepared by dynamic vulcanization of the multimodal copolymer rubber in the presence of a non-vulcanizing thermoplastic polymer. Dynamic vulcanization can include a vulcanization or curing process where the rubber can be crosslinked under conditions of high shear at a temperature above the melting point of the thermoplastic polymer. In one embodiment, the rubber can be simultaneously crosslinked and dispersed as fine particles within the thermoplastic matrix, although other morphologies may also exist.

In one or more embodiments, dynamic vulcanization can be achieved by employing a continuous process. Continuous processes can include those processes where dynamic vulcanization of the rubber is continuously achieved, thermoplastic vulcanizate product is continuously removed or collected from the system, and/or one or more raw materials or ingredients are continuously fed to the system during the time that it is desirable to produce or manufacture the product.

In one or more embodiments, continuous dynamic vulcanization can be effected within a continuous mixing reactor, which may also be referred to as a continuous mixer. Continuous mixing reactors can include those reactors that can be continuously fed ingredients and that can continuously have product removed therefrom. Examples of continuous mixing reactors include twin screw or multi-screw extruders, e.g., a ring extruder. Methods and equipment for continuously preparing TPV compositions are described in U.S. Pat. Nos. 4,311,628, 4,594,390, 5,656,693, 6,147,160, and 6,042,260, as well as WO 2004/009327 A1, which are incorporated herein by reference. It is recognized that methods employing low shear rates can also be used. The temperature of the blend as it passes through the various barrel sections or locations of a continuous reactor can be varied as is commonly known in the art. In particular, the temperature within the cure zone can be controlled or manipulated according to the half-life of the curative material employed.

In one or more embodiments, preparation of the TPV composition can be achieved by introducing each ingredient of the TPV composition to a continuous mixing reactor for vulcanization. In other embodiments, certain ingredients can be combined to form a pre-vulcanization blend before this blend is introduced to the continuous mixing reactor along with other ingredients not included in the pre-vulcanization blend. Preferably, the pre-vulcanization blend contains the ingredients that are include powders and their binder such as the multimodal copolymer rubber, which can be dusted with powder, the filler, and the curing agent; however, the pre-vulcanization blend can contain any of the ingredients being used to prepare the TPV composition.

### EXAMPLES

The foregoing discussion can be further described with reference to the following non-limiting examples.

Six TPV compositions (Examples 1-6) were made that contained one of the metallocene-based EPDM rubbers shown in Table 1 below (i.e., M-EPDM I and M-EPDM II). M-EPDM I is Vistalon™ 5601, and M-EPDM II is Vistalon™ 5702, both of which are commercially available from ExxonMobil. Certain characteristics of M-EPDM I and M-EPDM II are presented in Table 1. M-EPDM I and M-EPDM II are non-oil extended, multimodal, EPDM copolymers prepared using advanced metallocene catalyst technology and are available in pellet form. These copolymers are often referred to as reverse-bimodal copolymers and have a minor (<50 wt %) polymer fraction with a Mooney viscosity above 120 ML(1+4@125° C.) and a major (>50 wt %) polymer fraction with a Mooney viscosity lower than 120 ML(1+4@125° C.). The overall Mooney Viscosity of these copolymers is less than or equal to about 90 ML (1+4@125° C.). They also have a diene content of about 5 wt %, an ethylene content (C2) without diene of greater than or equal to about 64 wt %, an MWD of less than 3.5, and a BI of greater than 0.85.

Two comparative TPV compositions (Comparative Examples 1-2) were also made that contained the Ziegler-Natta EPDM rubber presented in Table 1 below (ZN-EPDM). ZN-EPDM is Vistalon 3666, which is commercially available from ExxonMobil. ZN-EPDM is a 75 phr oil-extended, mono-modal, branched EPDM copolymer prepared using conventional Zigler-Natta catalyst. Certain characteristics of ZN-EPDM are provided in Table 1. ZN-EPDM has a Mooney viscosity (ML, 1+4@125° C.) of about 50 after the addition of oil, an intrinsic viscosity in decalin at 135° C. of about 4 dl/g, a M_{w} of about 850 kg/mole, a Mₙ of about 170 kg/mole, an MWD of greater than 5, and a BI of about 0.5. The ZN-EPDM also has an ethylene (C₂) content without diene of about 64 wt %. and a diene content of about 4.2 wt %.

TABLE 1
Characteristics of EPDM Rubbers Used in
Examples 1-6 and Comparative Examples 1-2

| | 1^{st} Fraction | | 2^{nd} Fraction | | Blend | | Oil | | Diene | C₂ |
|---|---|---|---|---|---|---|---|---|---|---|
| Rubber | MST | wt % | ML | wt % | ML | MST | PHR | BI | wt % | wt % |
| ZN-EPDM | 50 | N/A | N/A | N/A | 242 | 50 | 75 | 0.5 | 4.2 | 64 |
| M-EPDM I | 65 | 30 | 72 | 70 | 72 | 14 | 0 | 0.94 | 5.0 | 69 |
| M-EPDM II | 65 | 30 | 90 | 70 | 90 | 17 | 0 | N/A | 5.5 | 71 |

Table 2 below provides the particular metallocene-based EPDM rubber used in Ex.1-6 and the amount of ZN-EPDM rubber used in C.Ex.1-2. The TPV compositions of Ex.1-6 and C.Ex.1-2 were prepared by dynamically vulcanizing the rubber within a twin-screw extruder. The solid ingredients, i.e., the rubber, a mixture of thermoplastic polyolefins, a curative material, curing agents, and fillers, were added to the feed throat of the extruder and underwent melt mixing to achieve a blend, thereby placing the thermoplastic polyolefins mixture in its molten state and curing the rubber. The thermoplastic polyolefins used was a mixture of polypropylene and polyethylene. The specific amounts of thermoplastic polyolefins used in the inventive TPV compositions of Ex.1-6 were varied as shown in Table 2 to achieve comparable hardness levels to the TPV compositions of C.Ex.1-2 and an overall balance of physical properties as well as processing performance. For Ex.1-6 and C.Ex.1-2, the curative material used was a resole-type phenolic resin that included a blend of octylphenol and nonylphenol formaldehyde (0.5 to 10 phr). The curing agents used were zinc oxide and stannous chloride (0.5 to 5 phr). For Ex.1-6, carbon black (1 to 40 phr) was used as a first filler, and calcium carbonate (0 to 100 phr) was used as a second inorganic mineral filler. For C.Ex.1-2, carbon black (1 to 40 phr) was used as a first filler, and clay (0 to 100 phr) was used as a second inorganic mineral filler.

Paraffinic oil was added to the extruder both before and after cure in the amounts set forth in Table 2. Since the TPV compositions of C.Ex.1-2 were prepared with oil-extended rubber, more amounts of oil (over 2 to 10 folds) were included in the rubber before cure than after cure. In contrast to conventional TPV compositions, the TPV compositions of Ex,1-6 were made by the addition of less oil before cure and more oil after cure, allowing in-process oil extension of the non-oil extended metallocene EPDM rubber. It is believed that this in-process oil extension helped achieve the optimum TPV phase morphology and thus provided for an good overall balance of physical and aesthetic properties in the inventive TPV compositions of Ex.1-6.

TABLE 2
Compositions of Examples 1-6 and Comparative Examples 1-2

| | C. Ex. 1 | C. Ex. 2 | Ex. 1 | Ex. 2 | Ex. 3 | Ex. 4 | Ex. 5 | Ex. 6 |
|---|---|---|---|---|---|---|---|---|
| ZN-EPDM (phr) | 175 | 175 | — | — | — | — | — | — |
| M-EPDM I (phr) | — | — | 100 | 100 | 100 | — | 100 | — |
| M-EPDM II (phr) | — | — | — | — | — | 100 | — | 100 |
| Precure Oil (phr) | 13 | 3 | 37 | 37 | 38 | 38 | 37 | 38 |
| Postcure Oil (phr) | 47 | 30 | 84 | 78 | 83 | 83 | 84 | 83 |
| Total Oil (phr) | 135 | 108 | 121 | 115 | 122 | 122 | 121 | 122 |
| Thermoplastic Polyolefins (phr) | 66 | 63 | 123 | 123 | 160 | 160 | 123 | 159 |
| Carbon Black (phr) | 10.1 | 2.1 | 2.8 | 2.8 | 4.6 | 4.6 | 2.8 | 3.9 |
| Filler (phr) | 42 | 40 | 48 | 48 | 64 | 64 | 6 | 8 |
| Curing Resin (phr) | 3.8 | 1.0 | 3.8 | 1.3 | 3.8 | 3.8 | 3.8 | 3.8 |
| ZnO (phr) | 1.5 | 1.5 | 1.5 | 1.5 | 1.5 | 1.5 | 1.5 | 1.5 |
| Tin Chloride (phr) | 0.75 | 0.74 | 0.75 | 0.75 | 0.74 | 0.74 | 0.75 | 0.74 |

Various properties of the TPV compositions of Ex.1-6 and C.Ex.1-2 were determined as 15 follows and tabulated in Table 3 below. Specific gravity was measured according to TPE0105 based on IS01183. Hardness was determined according to TPE0189 based on ISO 868 with a fifteen-second time interval. LCR viscosity was determined according to SOP-211 based on ISO 11443 at 204° C. Compression Set was determined according to ASTM D395 at 25% compression for 22 hours at room temperature (RT) and at 70° C. Modulus at 100% elongation (M100), ultimate tensile strength, and elongation at break (%) were determined according to ISO 37 at 23° C. at 50 mm/min by using an Instron testing machine.

Extrusion surface roughness (ESR) is reported as an arithmetic average of surface irregularity (Ra) in microinches. Surface irregularity was measured as follows. Approximately 1 kg (2 lbs.) of the TPV composition to be tested was fed into a 1″ or 1 ½″ diameter extruder equipped with a 24:1 length/diameter screw having a 3.0 to 3.5 compression ratio. The extruder was fitted to with a strip die that was 25.4 mm (1″) wide×0.5 mm (0.019″) thick×7-10mm (0.25 to 0.40″) length. A breaker plate was used with the die, but no screen pack was placed in front of the breaker plate. Approximate temperature profile of the extruder was as follows: zone 1=180° C. (feed zone); zone 2=190° C.; zone 3=200° C.; zone 4=205° C. (die zone). When the zone temperatures were reached, the screw was activated. Screw speed was set to maintain an output of approximately 50 g/min. For the first 5 minutes of extrusion, the extruder was flushed and the extruded material was discarded. A strip approximately 30.5 cm (12″) in length was extruded on a flat substrate placed directly under and touching the underside of the die. Three representative samples were collected in this manner. ESR was measured on the samples using a model EMD-04000-W5 Surfanalyzer System 4000 including a universal probe with a 200 mg stylus force and a Surfanalyzer proper tip type EPT-01049 (0.025 mm (0.0001″) stylus radius).

Bonding strength to the TPV composition of C.Ex.1 was measured by preparing a joint dogbone specimen first and then testing it in the Instron machine. The joint dog bone was prepared by directly injection molding half of the specimen of TPV composition being tested over another half of the TPV composition of C.Ex.1. The half substrate of the TPV composition of C.Ex.1. was prepared by cutting the whole injection molded dog bone in the middle.

TABLE 3
Properties of Examples 1-6 and Comparative Examples 1-2

| | C. Ex. 1 | C. Ex. 2 | Ex. 1 | Ex. 2 | Ex. 3 | Ex. 4 | Ex. 5 | Ex. 6 |
|---|---|---|---|---|---|---|---|---|
| Specific Gravity | 0.97 | 0.97 | 0.96 | 0.96 | 0.99 | 0.97 | 0.90 | 0.91 |
| Hardness (Shore A) | 75 | 79 | 80 | 80 | 85 | 86 | 80 | 85 |
| LCR Viscosity @ 200 s⁻¹ (Pa*s) | 347 | 334 | 326 | 322 | 337 | 335 | 307 | 313 |
| LCR Viscosity @ 1200 s⁻¹ (Pa*s) | 88 | 88 | 90 | 92 | 87 | 85 | 86 | 83 |
| M100 (MPa) | 3.3 | 3.1 | 3.5 | 3.2 | 4.2 | 4.4 | 3.3 | 4.3 |
| Ultimate Tensile Strength (MPa) | 6.5 | 5.2 | 6.8 | 5.8 | 6.5 | 7.3 | 7.2 | 6.2 |
| Elongation at Break (%) | 348 | 526 | 523 | 615 | 506 | 521 | 606 | 399 |
| Compression Set at RT (%) | 17 | 26 | 27 | 31 | 29 | NA | 26 | 29 |
| Compression Set at 70° C. (%) | 28 | 47 | 36 | 49 | 55 | NA | 38 | 47 |
| ESR (μin) | 72 | 60 | 50 | 37 | 34 | 29 | 38 | 195 |
| Bonding Strength (MPa) | 2.8 | 2.5 | NA | NA | 3.1 | NA | NA | NA |

Surprisingly, a good balance of properties was obtained for the inventive TPV compositions of Ex.1-6, which contained non-oil extended metallocene-based EPDM rubber. The physical, processing, and aesthetic performance of the TPV compositions of Ex.1-6 was unexpectedly better than or comparable to the performance of the TPV compositions of C.Ex.1-2, which contained oil extended Zielger-Natta based EPDM rubber while generally having similar density levels. For example, the hardness values of the TPV compositions of Ex.1-6 were advantageously higher and the ESR values of Ex.1-5 were advantageously lower than those of the TPV compositions of C.Ex.1-2. Also, the bonding strength of the TPV composition of Ex. 3 was surprisingly higher than the bonding strengths of the TPV compositions of C.Ex.1-2. For the TPV compositions of Ex.1-6, the ultimate tensile strength values were above 5.5, the elongation at break values were above 395%, the compressions set values were below 35% at RT and below 60% at 70° C., and the ESR values were generally below 55 μin (for Ex.1-5). The processing and aesthetics performance, as measured by LCR apparent viscosity at a shear rate of 200s⁻¹ desirably ranged from about 300 to 500 Pa*s. In addition, the inventive TPV compositions of Ex.5-6 demonstrated an excellent overall balance of properties while offering reduced densities.

### LISTING OF EMBODIMENTS

This disclosure can further include any one or more of the following non-limiting embodiments:

1. A thermoplastic vulcanizate composition, comprising: (a) a multimodal copolymer rubber, comprising: ethylene derived units; greater than 50 wt % and less than 100 wt % of a major polymer fraction having a Mooney viscosity of from about 15 ML(1+4@125° C.) to about 120 ML(1+4@125° C.), based on a total weight of the multimodal copolymer rubber; greater than 0 wt % and less than 50 wt % of a minor polymer fraction having a Mooney viscosity of from about 120 ML(1+4@125° C.) to about 1,500 ML(1+4@125° C.), based on the total weight of the multimodal copolymer rubber; an average molecular weight distribution (Mw/Mn) of from about 2.0 to about 4.5; an average branching index of from about 0.7 and to about 1.0; and less than 10 parts by weight oil per 100 parts by weight of the multimodal copolymer rubber; (b) at least one other oil; (c) at least one thermoplastic polymer; and (d) a curing system comprising at least one curative material and at least one curing agent.

2. The thermoplastic vulcanizate composition of embodiment 1, wherein the multimodal copolymer rubber is formed using a metallocene catalyst and comprises: from about 45 wt % to about 80 wt % of the ethylene derived units; about 1 wt % to about 10 wt % of non-conjugated diene derived units; a remainder of polymer units derived from an α-olefin; and an overall Mooney viscosity of from about 20 ML(1+4@125° C.) to about 90 ML(1+4@125° C.), wherein all weight percentages are based on the total weight of the multimodal copolymer rubber.

3. The thermoplastic vulcanizate composition of embodiment 1 or 2, further comprising particles of vulcanized rubber dispersed in a continuous phase or a matrix of the at least one thermoplastic polymer.

4. The thermoplastic vulcanizate composition of embodiments 1 to 3, wherein the multimodal copolymer rubber is in the form of particles having a particle size of from about 0.5 mm to about 15.0 mm.

5. The thermoplastic vulcanizate composition of embodiments 1 to 4, wherein the at least one thermoplastic polymer comprises polypropylene, polyethylene, polyethylene copolymer, polypropylene copolymer, copolymer of ethylene and propylene, or combinations thereof, and wherein an amount of the at least one thermoplastic polymer in the thermoplastic vulcanizate composition is from about 20 phr to about 600 phr.

6. The thermoplastic vulcanizate composition of embodiment 5, wherein the polypropylene comprises recycled polypropylene.

7. The thermoplastic vulcanizate composition of embodiment 5, wherein the polyethylene comprises recycled polyethylene.

8. The thermoplastic vulcanizate composition of embodiments 1 to 7, wherein an amount of the at least one other oil in the thermoplastic vulcanizate composition is from about 10 phr to about 250 phr.

9. The thermoplastic vulcanizate composition of embodiments 1 to 8, wherein the at least one curative material comprises a phenolic-based polymer present in the thermoplastic vulcanizate composition in an amount of about 0.1 phr to about 20.0 phr.

10. The thermoplastic vulcanizate composition of embodiments 1 to 9, further comprising a filler present in the thermoplastic vulcanizate composition in an amount of about 0 phr to about 300 phr.

11. The thermoplastic vulcanizate composition of embodiments 1 to 10, further comprising a hardness of from about 30 ShoreA to about 55 ShoreD, an elongation at break of from about 250% to about 900%, an ultimate tensile strength of from about 2.0 MPa about 15.0 MPa., an apparent viscosity at 1,200s⁻¹ of from about 30 Pa*s and to about 150 Pa*s, a specific gravity of from about 0.86 to about 1.40, a bonding strength of from about 1.0 MPa to about 5.0 MPa, and an extrusion surface roughness of from about 20 and to about 200.

12. A process for making a thermoplastic vulcanizate composition, comprising: introducing a multimodal copolymer rubber to a reactor, the multimodal copolymer rubber comprising: ethylene derived units; greater than 50 wt % and less than 100 wt % of a major polymer fraction having a Mooney viscosity of from about 15 ML(1+4@125° C.) to about 120 ML(1+4@125° C.), based on a total weight of the multimodal copolymer rubber; greater than 0 wt % and less than 50 wt % of a minor polymer fraction having a Mooney viscosity of from about 120 ML(1+4@125° C.) to about 1,500 ML(1+4@125° C.), based on the total weight of the multimodal copolymer rubber; an average molecular weight distribution (Mw/Mn) of from about 2.0 to about 4.5; an average branching index of from about 0.7 and to about 1.0; and less than 10 parts by weight oil per 100 parts by weight of the multimodal copolymer rubber; concurrently or sequentially with respect to the multimodal copolymer rubber; introducing at least one thermoplastic polymer, at least one other oil, and a curing system to the reactor; melt mixing the multimodal copolymer rubber, the at least one thermoplastic polymer, and the curing system; and curing the multimodal copolymer rubber.

13. The process of embodiment 12, wherein said curing the multimodal copolymer rubber forms particles of the rubber dispersed in a continuous phase or a matrix of the at least one thermoplastic polymer.

14. The process of embodiment 12 or 13, wherein the at least one other oil is introduced before said curing the multimodal copolymer rubber, and further comprising introducing additional oil subsequent to said curing the multimodal copolymer rubber, wherein a ratio of the at least one other oil to the additional oil is less than about 1.

15. The process of embodiments 12 to 14, wherein the multimodal copolymer rubber is formed using a metallocene catalyst and comprises: from about 45 wt % to about 80 wt % of the ethylene derived units; from about 1 wt % to about 10 wt % of non-conjugated diene derived units; a remainder of polymer units derived from an α-olefin; and an overall Mooney viscosity of about 20 ML(1+4@125° C.) to about 90 ML(1+4@125° C.), wherein all weight percentages are based on the total weight of the multimodal copolymer rubber.

16. The process of embodiments 12 to 15, wherein the multimodal copolymer rubber is in the form of particles having a particle size of from about 0.5 mm to about 15.0 mm.

17. The process of embodiments 12 to 16, wherein the at least one thermoplastic polymer comprises polypropylene, polyethylene, polyethylene copolymer, polypropylene copolymer, copolymer of ethylene and propylene, or combinations thereof, and wherein an amount of the at least one thermoplastic polymer in the thermoplastic vulcanizate composition is from about 20 phr to about 600 phr.

18. The process of embodiment 17, wherein the polypropylene comprises recycled polypropylene, and wherein the polyethylene comprises recycled polyethylene.

19. The process of embodiments 12 to 18, wherein an amount of the at least one other oil in the thermoplastic vulcanizate composition is from about 10 phr to about 250 phr, wherein the curative system comprises at least one curative material and at least one curing agent, and wherein the at least one curative material comprises a phenolic-based polymer present in the thermoplastic vulcanizate composition in an amount of about 0.1 phr to about 20.0 phr.

20. The process of embodiments 12 to 19, further comprising, concurrently or sequentially with respect to the multimodal copolymer rubber; introducing a filler to the reactor in an amount of about 0 phr to about 300 phr.

21. A process for making a thermoplastic vulcanizate, comprising: making a pre-vulcanization blend, comprising (a) a multimodal copolymer rubber, comprising: ethylene derived units; greater than 50 wt % and less than 100 wt % of a major polymer fraction having a first

Mooney viscosity of from about 15 ML(1+4@125° C.) to about 120 ML(1+4@125° C.), based on a total weight of the multimodal copolymer rubber; greater than 0 wt % and less than 50 wt % of a minor polymer fraction having a second Mooney viscosity less than the first Mooney viscosity; less than 10 parts by weight oil per 100 parts by weight the multimodal copolymer rubber; and (b) at least one curing agent powder; introducing the pre-vulcanization blend to a reactor; concurrently or sequentially with respect to the pre-vulcanization blend, introducing at least one thermoplastic polymer, at least one other oil, and at least one curative material to the reactor; melt mixing the pre-vulcanization blend, the at least one thermoplastic polymer, and the at least one curative material; and curing the multimodal copolymer rubber.

22. The process of embodiment 21, wherein said making the pre-vulcanization blend is performed at a different location than said introducing the pre-vulcanization blend to a reactor.

23. The process of embodiment 21 or 22, wherein the pre-vulcanization blend further comprises at least one filler powder, the at least one thermoplastic polymer, the at least one other oil, the at least one curative material, or combinations thereof.

24. The process of embodiment 23, wherein the at least one filler powder comprises calcium carbonate, carbon black, talc, or combinations thereof, and wherein the at least one curing agent powder comprises a metal oxide, stannous chloride, or combinations thereof

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

What is claimed is:

1. A thermoplastic vulcanizate composition, comprising:
(a) a multimodal copolymer rubber, comprising:
ethylene derived units;
greater than 50 wt % and less than 100 wt % of a major polymer fraction having a Mooney viscosity of from about 15 ML(1+4@125° C.) to about 120 ML(1+4@125° C.), based on a total weight of the multimodal copolymer rubber;
greater than 0 wt % and less than 50 wt % of a minor polymer fraction having a Mooney viscosity of from about 120 ML(1+4@125° C.) to about 1,500 ML(1+4@125° C.), based on the total weight of the multimodal copolymer rubber;
an average molecular weight distribution (M_{w}/Mₙ) of from about 2.0 to about 4.5;
an average branching index of from about 0.7 and to about 1.0; and
less than 10 parts by weight oil per 100 parts by weight of the multimodal copolymer rubber;
(b) at least one other oil;
(c) at least one thermoplastic polymer; and
(d) a curing system comprising at least one curative material and at least one curing agent.

2. The thermoplastic vulcanizate composition of claim 1, wherein the multimodal copolymer rubber is formed using a metallocene catalyst and comprises: from about 45 wt % to about 80 wt % of the ethylene derived units; about 1 wt % to about 10 wt % of non-conjugated diene derived units; a remainder of polymer units derived from an α-olefin; and an overall Mooney viscosity of from about 20 ML(1+4@125° C.) to about 90 ML(1+4@125° C.), wherein all weight percentages are based on the total weight of the multimodal copolymer rubber.

3. The thermoplastic vulcanizate composition of claim 1, further comprising particles of vulcanized rubber dispersed in a continuous phase or a matrix of the at least one thermoplastic polymer.

4. The thermoplastic vulcanizate composition of claim 1, wherein the multimodal copolymer rubber is in the form of particles having a particle size of from about 0.5 mm to about 15.0 mm.

5. The thermoplastic vulcanizate composition of claim 1, wherein the at least one thermoplastic polymer comprises polypropylene, polyethylene, polyethylene copolymer, polypropylene copolymer, copolymer of ethylene and propylene, or combinations thereof, and wherein an amount of the at least one thermoplastic polymer in the thermoplastic vulcanizate composition is from about 20 phr to about 600 phr.

6. The thermoplastic vulcanizate composition of claim 5, wherein the polypropylene comprises recycled polypropylene.

7. The thermoplastic vulcanizate composition of claim 5, wherein the polyethylene comprises recycled polyethylene.

8. The thermoplastic vulcanizate composition of claim 1, wherein an amount of the at least one other oil in the thermoplastic vulcanizate composition is from about 10 phr to about 250 phr.

9. The thermoplastic vulcanizate composition of claim 1, wherein the at least one curative material comprises a phenolic-based polymer present in the thermoplastic vulcanizate composition in an amount of about 0.1 phr to about 20.0 phr.

10. The thermoplastic vulcanizate composition of claim 1, further comprising a filler present in the thermoplastic vulcanizate composition in an amount of about 0 phr to about 300 phr.

11. The thermoplastic vulcanizate composition of claim 1, further comprising a hardness of from about 30 ShoreA to about 55 ShoreD, an elongation at break of from about 250% to about 900%, an ultimate tensile strength of from about 2.0 MPa about 15.0 MPa., an apparent viscosity at 1,200s⁻¹ of from about 30 Pa*s and to about 150 Pa*s, a specific gravity of from about 0.86 to about 1.40, a bonding strength of from about 1.0 MPa to about 5.0 MPa, and an extrusion surface roughness of from about 20 and to about 200.

12. A process for making a thermoplastic vulcanizate composition, comprising:
introducing a multimodal copolymer rubber to a reactor, the multimodal copolymer rubber comprising:
ethylene derived units;
greater than 50 wt % and less than 100 wt % of a major polymer fraction having a Mooney viscosity of from about 15 ML(1+4@125° C.) to about 120 ML(1+4@125° C.), based on a total weight of the multimodal copolymer rubber;
greater than 0 wt % and less than 50 wt % of a minor polymer fraction having a Mooney viscosity of from about 120 ML(1+4@125° C.) to about 1,500 ML(1+4@125° C.), based on the total weight of the multimodal copolymer rubber;
an average molecular weight distribution (M_{w}/Mₙ) of from about 2.0 to about 4.5;
an average branching index of from about 0.7 and to about 1.0; and
less than 10 parts by weight oil per 100 parts by weight of the multimodal copolymer rubber;
concurrently or sequentially with respect to the multimodal copolymer rubber; introducing at least one thermoplastic polymer, at least one other oil, and a curing system to the reactor;
melt mixing the multimodal copolymer rubber, the at least one thermoplastic polymer, and the curing system; and
curing the multimodal copolymer rubber.

13. The process of claim 12, wherein said curing the multimodal copolymer rubber forms particles of the rubber dispersed in a continuous phase or a matrix of the at least one thermoplastic polymer.

14. The process of claim 12, wherein the at least one other oil is introduced before said curing the multimodal copolymer rubber, and further comprising introducing additional oil subsequent to said curing the multimodal copolymer rubber, wherein a ratio of the at least one other oil to the additional oil is less than about 1.

15. The process of claim 12, wherein the multimodal copolymer rubber is formed using a metallocene catalyst and comprises: from about 45 wt % to about 80 wt % of the ethylene derived units; from about 1 wt % to about 10 wt % of non-conjugated diene derived units; a remainder of polymer units derived from an α-olefin; and an overall Mooney viscosity of about 20 ML(1+4@125° C.) to about 90 ML(1+4@125° C.), wherein all weight percentages are based on the total weight of the multimodal copolymer rubber.

16. The process of claim 12, wherein the multimodal copolymer rubber is in the form of particles having a particle size of from about 0.5 mm to about 15.0 mm.

17. The process of claim 12, wherein the at least one thermoplastic polymer comprises polypropylene, polyethylene, polyethylene copolymer, polypropylene copolymer, copolymer of ethylene and propylene, or combinations thereof, and wherein an amount of the at least one thermoplastic polymer in the thermoplastic vulcanizate composition is from about 20 phr to about 600 phr.

18. The process of claim 17, wherein the polypropylene comprises recycled polypropylene, and wherein the polyethylene comprises recycled polyethylene.

19. The process of claim 12, wherein an amount of the at least one other oil in the thermoplastic vulcanizate composition is from about 10 phr to about 250 phr, wherein the curative system comprises at least one curative material and at least one curing agent, and wherein the at least one curative material comprises a phenolic-based polymer present in the thermoplastic vulcanizate composition in an amount of about 0.1 phr to about 20.0 phr.

20. The process of claim 12, further comprising, concurrently or sequentially with respect to the multimodal copolymer rubber; introducing a filler to the reactor in an amount of about 0 phr to about 300 phr.

21. A process for making a thermoplastic vulcanizate, comprising:
making a pre-vulcanization blend, comprising
(a) a multimodal copolymer rubber, comprising:
ethylene derived units;
greater than 50 wt % and less than 100 wt % of a major polymer fraction having a first Mooney viscosity of from about 15 ML(1+4@125° C.) to about 120 ML(1+4@125° C.), based on a total weight of the multimodal copolymer rubber;
greater than 0 wt % and less than 50 wt % of a minor polymer fraction having a second Mooney viscosity less than the first Mooney viscosity;
less than 10 parts by weight oil per 100 parts by weight the multimodal copolymer rubber; and
(b) at least one curing agent powder;
introducing the pre-vulcanization blend to a reactor;
concurrently or sequentially with respect to the pre-vulcanization blend, introducing at least one thermoplastic polymer, at least one other oil, and at least one curative material to the reactor;
melt mixing the pre-vulcanization blend, the at least one thermoplastic polymer, and the at least one curative material; and
curing the multimodal copolymer rubber.

22. The process of claim 21, wherein said making the pre-vulcanization blend is performed at a different location than said introducing the pre-vulcanization blend to a reactor.

23. The process of claim 21, wherein the pre-vulcanization blend further comprises at least one filler powder, the at least one thermoplastic polymer, the at least one other oil, the at least one curative material, or combinations thereof.

24. The process of claim 23, wherein the at least one filler powder comprises calcium carbonate, carbon black, talc, or combinations thereof, and wherein the at least one curing agent powder comprises a metal oxide, stannous chloride, or combinations thereof.
